(19) United States
(12) Patent Application Publication
(10) Pub. No.: US 2022/0279959 A1
(43) Pub. Date: Sep. 8, 2022

(54) FULLY AUTOMATIC COFFEE MACHINE

(71) Applicant: Jura Elektroapparate AG, Niederbuchsiten (CH)

(72) Inventor: Philipp BAUR, Utzenstorf (CH)

(73) Assignee: Jura Elektroapparate AG, Niederbuchsiten (CH)

(21) Appl. No.: 17/628,261

(22) PCT Filed: Jul. 24, 2020
(86) PCT No.: PCT/EP2020/070918

§ 371 Date: Jan. 19, 2022

(30) Foreign Application Priority Data
Jul. 24, 2019 (EP) 19188196.0

(51) Int. Cl. A47J 31/44; A47J 31/52

(52) U.S. Cl. CPC A47J 31/4403; A47J 31/52

(57) ABSTRACT

A fully automatic coffee machine (1) including a detachable water tank (5) that is retained by a magnetic holding force on a base device (2) of the fully automatic coffee machine (1).

### TECHNICAL FIELD

The invention concerns a fully automatic coffee machine with a water tank which is detachable from a base device and has a water outlet, wherein the water outlet can be connected to a connection opening formed on the base device for water extraction during use.

### BACKGROUND

Such fully automatic coffee machines are known in which the water tank is detached from the base device for filling. For stable holding of the water tank on the base device, previously, mutually complementary, mechanical, form-fit guide and fixing means were formed on the water tank and on the base device which extended over the height of the water tank. These mechanical guide means frequently constitute a peripheral condition which must be taken into account in a design of the fully automatic coffee machine.

SuperautoPro: “Jura Impressa S9 One-Touch Video”, Youtube, 22 Jan. 2018, page 2 pp., https://www.youtube.com/watch?v=b90-AKHyo3E, shows a fully automatic coffee machine with a water tank which is detachable from a base device.

CN 208 192 933 U discloses a soya bean milk machine in which a magnetic element is formed on a base body and an elongate metal plate of iron or steel is formed on a water container.

EP 3 015 035 A1 describes a water container for a drinks machine, and a drinks machine, wherein the water container has a filling opening which can be closed by means of a lid, wherein in the attached state of the water container on the drinks machine, a filling region is defined above the filling opening, and wherein the lid can be guided by means of a guide device which allows pivoting of the lid from the filling region into at least one established or establishable opening position, so that the filling region is freely accessible at least from above.

### SUMMARY

The invention is based on the object of providing a fully automatic coffee machine which allows greater freedom of design.

To achieve said object, the invention provides for the use of one or more of the features disclosed herein. In particular, in a fully automatic coffee machine of the type described initially, the invention proposes that the water tank is held magnetically on the base device, that the water tank has a water container and a lid which is connected thereto preferably via a hinge, and that a magnetically acting coupling element for magnetic holding is arranged on the lid. The invention thus allows fixing of the water tank to the base device without the need for mechanical guide means at that location. This allows a free design of an outer face of the water tank, in particular in the contact region with the base device. Here, the water tank may be magnetically held for example at a location spaced from the connection opening.

An arrangement of the coupling element on the lid has the advantage that a geometry of the water container can be kept simple. This allows production of the water container by injection molding. The invention here uses the knowledge that a lid usually has a more complex shape than an associated container, so arranging and/or forming the coupling element on the lid requires less effort in production.

The magnetically acting coupling element may for example be a permanent magnet and/or a material which is magnetically drawn into a magnetic field. The use of a permanent magnet has the advantage that greater holding forces can be achieved with comparatively little space requirement. The use of a material which is drawn into a magnetic field, for example iron or an iron alloy, has the advantage that this allows low-cost production.

The water tank may for example comprise an open container and a lid.

Thus symmetrical water tanks may be used which appear identical on a front side and a back side.

Alternatively or additionally, to achieve said object, according to the invention the features of the second independent claim may be provided. In particular thus, in a fully automatic coffee machine of the type described initially, according to a second aspect of the invention, it is provided that the water tank is magnetically held on the base device at a location preferably spaced from the connection opening, and that a permanent magnet as a magnetically acting coupling element for magnetic holding is arranged on the water tank. This avoids a greater use of space which is frequently required with metal plates which close a magnetic circuit between two magnetic poles.

It is particularly favorable if the magnetic coupling is formed between a coupling element and a counter-coupling element, wherein the counter-coupling element has or forms a permanent magnet. It is advantageous here that greater holding forces can be achieved in a smaller space than with a combination of a permanent magnet and iron (or iron alloy).

It may be favorable here if the coupling element and/or the counter-coupling element are arranged so as to be movable, in particular rotatable about an axis which runs transversely and preferably perpendicularly to a magnetic dipole moment (e.g. of the respective other permanent magnet). Thus incorrect orientation which could lead to repulsion, for example from mounting errors, can be avoided and/or automatically corrected in that the coupling element and/or counter-coupling element orientate themselves accordingly.

It is favorable here if the coupling element and/or the counter-coupling element is configured as a ball. It is advantageous here that an exemplary ball autonomously achieves the correct orientation for generating a high holding force, in particular if the coupling element and/or counter-coupling element is configured as a permanent magnet.

The respective other part, i.e. the counter-coupling element and/or coupling element, may here also be configured as a bar magnet. This allows a dense output of field lines, leading to a high holding force.

Alternatively or additionally, to achieve said object, according to the invention the features of the third independent claim may also be provided. In particular thus, in a fully automatic coffee machine of the type described initially, according to a third aspect of the invention it is proposed that the water tank is magnetically held on the base device at a location preferably spaced from the connection opening, and that a magnetically acting counter-coupling element for magnetic holding is arranged on the base device, in particular spaced from the connection opening, under a cover made of plastic. In this way, the base device may be easier to clean.

The counter-coupling element here may for example be a permanent magnet and/or a material which is drawn into a magnetic field.

A pairing, already described, of two permanent magnets is particularly favorable for the magnetic coupling, since in this way a sufficient holding force can be achieved through the cover.

The cover may here be part of an encapsulation of the counter-coupling element. This facilitates assembly.

It is particularly favorable if the counter-coupling element is arranged movably in the encapsulation, for example with a degree of play, as has already been stated.

In one embodiment of the invention, it may be provided that the water outlet can be connected by push fit to the connection opening. It is advantageous here that the water tank can easily be removed and inserted. It is furthermore advantageous that the water tank at its lower end can be held by form fit via a push-fit connection. Here, it may be provided that a magnetic holding force of the magnetic holder is oriented transversely to a push-fit direction of the push-fit connection. In this way, tilting of the water tank about a fixed point formed by the push-fit connection can be prevented.

In one embodiment of the invention, it may be provided that a magnetically acting coupling element for magnetic holding is arranged on the water tank. Thus in a simple fashion, a magnetic holding force can be applied. The coupling element may for example be configured as a permanent magnet. Alternatively or additionally, the coupling element may for example be made of a material which is drawn into a magnetic field, for example a ferromagnetic metal. The coupling element may here be integrated in a wall of the water tank, in particular of the water container, for example inserted in an opening of the wall, molded into the wall and/or placed on the wall on the inside and/or outside.

The coupling element may alternatively or additionally be integrated in the lid. Thus an injection-molding tool for the water container is more easily obtainable. This is favorable if the water container itself has a complex shape, for example with curves and/or high side walls.

It may be provided here that the coupling element is arranged closer to a filling opening than to the water outlet. It is advantageous here that the additional holding of the water tank according to the invention may be formed at a greater distance from a support of the water tank, and/or above its center of gravity, at least in the filled state. This requires only slight (lateral) holding forces to keep the water tank stable.

In one embodiment of the invention, it may be provided that a magnetically acting counter-coupling element for magnetic holding is arranged on the base device. Thus in a simple fashion, a magnetic holding force can be applied to the water tank. The counter-coupling element may for example be configured as a permanent magnet. The counter-coupling element may alternatively or additionally also be made of a material which is drawn into a magnetic field, for example a ferromagnetic metal. It may be provided here that the counter-coupling element is arranged spaced from the connection opening. This design utilizes the fact that the connection opening is arranged close to the support for the water container. This allows the magnetic holding force to be formed as far as possible from this support. The magnetic holding force may thus be kept very low in order to hold the water tank securely in its upright position.

Preferably, the coupling element and the counter-coupling element are arranged in mutually corresponding positions.

In one embodiment of the invention, it may be provided that the connection opening is arranged below the counter-coupling element. It is advantageous here that the magnetic holding force can be introduced preferably vertically above a support of the water tank. Thus tilting of the water tank can be prevented with low holding force.

In one embodiment of the invention, it may be provided that the connection opening is formed on a support for the water tank. Thus in a simple fashion, the weight of the water tank can be received without loading the magnetic holder. The magnetic holding force may thus be designed low.

In one embodiment of the invention, it may be provided that the water tank has a smaller horizontal dimension, at least in a direction in which it is magnetically held, than its vertical dimension. Thus water tanks can be used in which for example the bottom face is smaller than a side face. In these water tanks, notoriously there is a risk of tilting, which can be prevented by the magnetic holder described. For example, it may be provided that the horizontal dimension amounts to maximum 50%, preferably maximum 20% of the vertical dimension. Thus tower-like water tanks may be used with practically unlimited design options.

In one embodiment of the invention, it may be provided that the water tank in the usage position lies against a side face of the base device which is free from guide means. This allows corresponding design of both the base device and the water tank separately. For example, it may be provided that the water tank lies over a large area against the side face. The mutually corresponding side faces may here be formed flat or have mutually complementary curves.

In an advantageous embodiment, it may be provided that the water tank comprises a water container and a lid. Thus a filling opening can easily be formed. Thus different tools may be used for production of the lid and water container. For example, it may be provided that the lid is connected to the water container. Thus the lid can be mounted captively. Preferably, the lid is connected to the water container via a hinge, for example via a double hinge of a folding arm. Use of a double hinge may be beneficial for easily overcoming the holding force on removal of the lid.

### BRIEF DESCRIPTION OF THE DRAWINGS

The invention is now described in more detail with reference to an exemplary embodiment, but is not restricted to this exemplary embodiment. Further exemplary embodiments arise from combinations of the features of individual or multiple claims, and/or with individual or multiple features of the exemplary embodiment.

The drawings show:

FIG. 1 a fully automatic coffee machine according to the invention in three-dimensional oblique view,

FIG. 2 the water tank from FIG. 1 with lid removed,

FIG. 3 an extract from FIG. 2,

FIG. 4 a vertical section through the water tank from FIG. 2,

FIG. 5 a detail of FIG. 4,

FIG. 6 the fully automatic coffee machine from FIG. 1 in a horizontal, sectional view,

FIG. 7 a horizontal, sectional illustration through the water tank with adjoining housing of the base device relating to the view in FIG. 6,

FIG. 8 a view of the back side of the removed water tank from FIG. 1,

FIG. 9 a view of the back side of the water tank from FIG. 8 with open lid,

FIG. 10 a view of a side of the water tank from FIG. 9,

FIG. 11 a view from above onto the water tank from FIG. 9, and

FIG. 12 a three-dimensional, oblique view of the fully automatic coffee machine from FIG. 1 with detached water tank.

### DETAILED DESCRIPTION

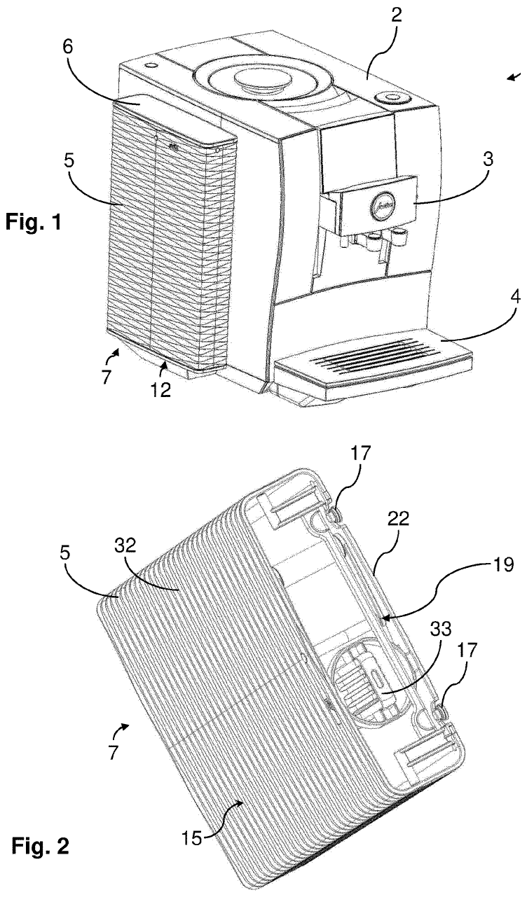

FIG. 1 shows a three-dimensional, oblique view of a fully automatic coffee machine 1 according to the invention.

The fully automatic coffee machine 1 has a base device 2 on which an output unit 3 is formed for the output of hot drinks, and further means (not shown) in the interior for the production of hot drinks. The base device 2 also has a cup support 4 on which cups or beakers can be placed below the output unit 3 in the known fashion, in order to extract the desired drink.

A water tank 5 is arranged on the base device 2 and provides a water store for preparation of drinks.

The water tank 5 has a lid 6 which can be removed for filling the water container 35. The water container 35 and the lid 6 substantially form the detachable water tank 5.

FIG. 2 shows the detached water tank 5 without lid 6.

On its underside 7, the water container 35 has a water outlet 8 via which the stored water can be output to the base device 2.

FIG. 9 shows the base device in FIG. 1 with detached water tank 5. In FIG. 9, the connection opening 9 can be seen which can be coupled to the water outlet 8 of the water tank 5 in order to conduct water into the base device 2.

For usage, the water tank 5 is placed on the connection opening 9 and held magnetically, in a manner to be described in more detail below, at a location 10 which is spaced from the connection opening 9 and corresponds to an upper region 11 of the water tank 5. The water outlet 8 is connected to the connection opening 9 by a push-fit movement oriented vertically along a push-fit connection 12. The magnetic holding force at the location 10 acts transversely to this push-fit direction 12. This gives a contact region 1 at the outer face 14 on a back side of the water tank 5.

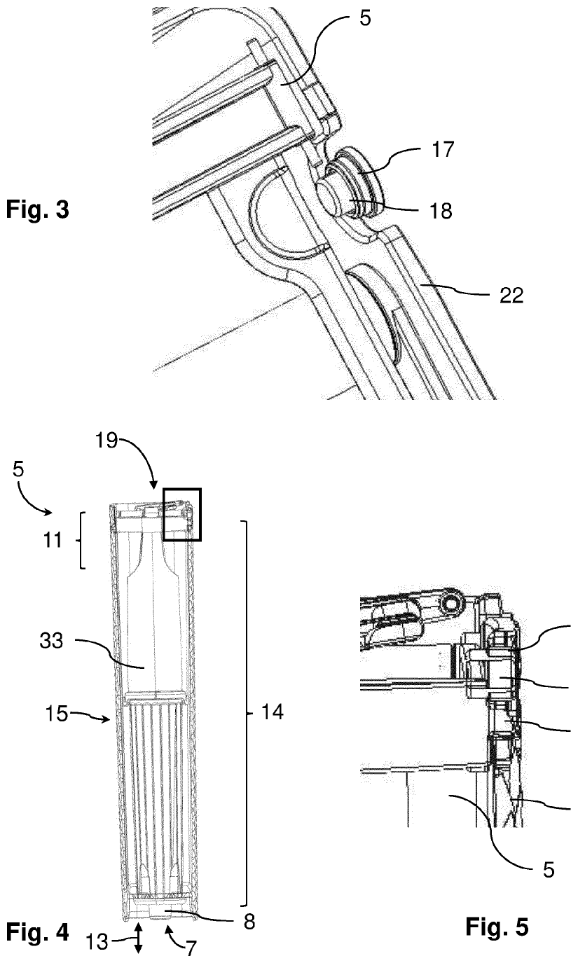

The magnetic holding force is created by a holder 16, which is shown in FIGS. 3, 5 and 7 and described in more detail below. It could be said that the holding force is oriented transversely to the push-fit direction 12.

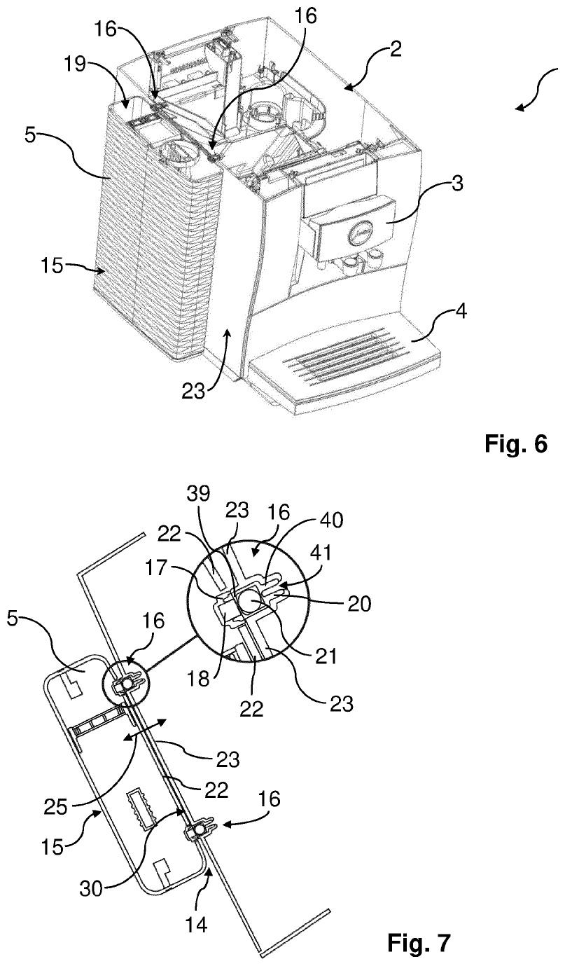

FIG. 3 here shows an enlargement from FIG. 2, FIG. 5 an enlargement of the top right-hand corner of FIG. 4, while FIG. 7 shows part of the two-dimensional sectional depiction relating to the three-dimensional sectional depiction in FIG. 6.

On the side of the water tank 5, a coupling element 17 with a permanent magnet 18 is formed.

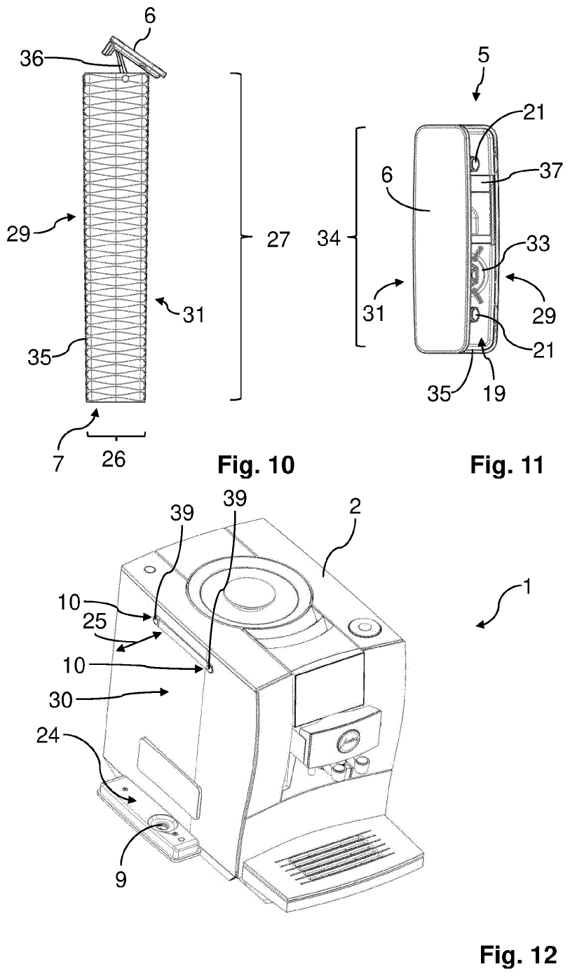

In FIGS. 9 to 11, it is evident that the coupling element 17 is formed on the lid 6. When the lid 6 is closed, the coupling element 17 is in the upper region 11 of the water container 35 and hence arranged closer to a filling opening 19 (see FIG. 2) than to the above-mentioned water outlet 8. The filling opening 19 can be closed by the lid 6.

The base device 2 has a corresponding counter-coupling element 20 with a permanent magnet 21. The permanent magnet 21 is oriented such that in interaction with the permanent magnet 18, the magnetic holding force is created which acts along a direction 25. Instead of the permanent magnet 21, a ferromagnetic body may also be formed which is drawn into the magnetic field of the permanent magnet 18 and hence attracted by the permanent magnet 18. Alternatively, the permanent magnet 18 may also be replaced by such a body.

Whereas the permanent magnet 18 may be molded or bonded into the lid 6, the permanent magnet 21, which may be configured as a ball, has a degree of play so that it is movably arranged in an encapsulation 40. The dipole of the permanent magnet 21 may thus easily orientate itself to the dipole of the permanent magnet 18, even if the permanent magnet 18 has been mounted in reverse. The permanent magnet 18 is here formed as a bar magnet.

In a further exemplary embodiment, the permanent magnet 18 is formed as a ball and arranged with a degree of play. The permanent magnet 21 may here be configured as a movable ball or be arranged immovably.

The encapsulation 40 has a cover 39 which is arranged on a connecting line between the coupling element 17 and the counter-coupling element 21. An opening 41 serves for screw fixing to the housing 23.

It is clear from the Figures that two identical holders 16 are formed with a mutual horizontal spacing.

The coupling element 17 is integrated in the wall 22 of the water tank 5. The counter-coupling element 20 is integrated in a housing 23 of the base device 2.

The connection opening 9 is integrated in a support 24 which receives the weight of the filled water tank 5.

The water tank 5 has a horizontal dimension 26, in the direction 25 of the magnetic holding force, which is smaller than a vertical dimension 27 of the water tank 5.

This gives an elongate bottom face 28 of the water tank 5 which is smaller than a largest side face 29 of the water tank 5.

The side face 29 is more than twice as large as the bottom face 28. For the present water tank 5, it could be said that all side faces, i.e. also the lateral side faces 38, are each significantly larger than the bottom face 28. This gives a water tank 5 of tower-like form.

The side faces 29, 31, 38 of the water tank are free from mechanical guide means with which a form-fit connection could be created. The same applies to the side face 30 of the base device 2.

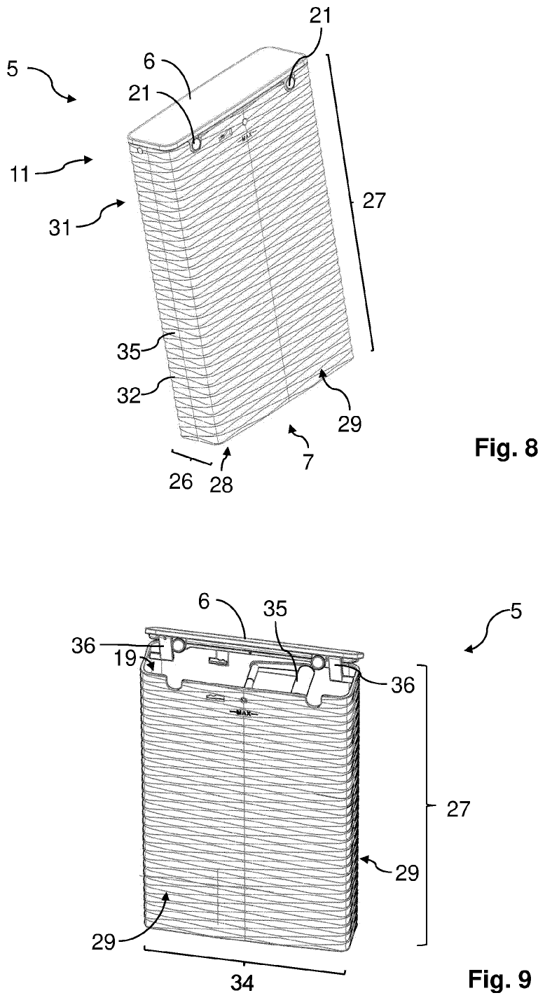

It can be said that the rear side face 29 of the water tank 5 in FIG. 8 is designed substantially the same as the front side face 31 of the water tank 5 from FIG. 1 or FIG. 2. The water tank 5 is thus externally symmetrical.

The side faces 29, 31, 38 of the water tank 35 are configured so as to be transparent, in order to show a fill level. They have a structure which only vaguely shows an interior of the water container 35. Thus in particular, a filter 33 could be concealed in the interior of the water container 35 (see FIG. 4).

In FIGS. 9 to 11, it is also evident that the lid 6 is attached captively to the water container 35. For this, the lid 6 is pivotably connected to the water container 35 via a folding arm 36. At each end, the folding arm 36 forms a respective hinge so the lid 6 can be completely pivoted away to facilitate filling and create space for a fold-out handle 37.

With the fully automatic coffee machine 1, it is proposed that a detachable water tank 5 is held by a magnetic holding force on a base device 2 of the fully automatic coffee machine 1.

### LIST OF REFERENCE SIGNS

1 Fully automatic coffee machine
2 Base device
3 Output unit
4 Cup support
5 Water tank
6 Lid
7 Underside of water tank
8 Water outlet
9 Connection opening
10 Location
11 Upper region of water tank
12 Push-fit connection
13 Push-fit direction
14 Contact region
15 Outer face
16 Holder
17 Coupling element
18 Permanent magnet
19 Filling opening
20 Counter-coupling element
21 Permanent magnet
22 Wall of water container
23 Housing of base device
24 Support for water container
25 Direction
26 Horizontal dimension
27 Vertical dimension
28 Bottom face of water container
29 (Rear) side face of water container
30 Side face of water container
31 (Front) Side face of water container
32 Structure
33 Filter
34 Horizontal dimension
35 Water container
36 Folding arm
37 Handle
38 (Lateral) side face of water container
39 Cover of 21

1. A fully automatic coffee machine (1), comprising:
a base device (2);
a water tank (5) which is detachable from the base device (2) and has a water outlet (8), the water outlet (8) is connectable to a connection opening (9) formed on the base device (2) for water extraction during use;
the water tank (5) is held magnetically on the base device (2);
the water tank (5) has a water container (35) and a lid (6) which is connected thereto and a magnetically acting coupling element (17) configured for magnetic holding (16) of the water tank (5) on the base device (2) is arranged on the lid (6).

2. The fully automatic coffee machine (1) as claimed in claim 1, wherein the water tank (5) is magnetically held on the base device (2) at a location (10) spaced from the connection opening (9), and the magnetically acting coupling element (17) comprises a permanent magnet (18).

3. The fully automatic coffee machine (1) as claimed in claim 1, wherein the magnetic holding (16) of the water tank on the base device is achieved by two permanent magnets (18, 21), with one of the permanent magnets forming the magnetically acting coupling element (17).

4. The fully automatic coffee machine (1) as claimed in claim 1, further comprising a counter-coupling element (20) arranged on the base device, and at least one of the coupling element (17) or the counter-coupling element (20) is arranged to be movable.

5. The fully automatic coffee machine (1) as claimed in claim 1, wherein the water tank (5) is magnetically held on the base device (2) at a location (10) spaced from the connection opening (9), and a magnetically acting counter-coupling element (20) configured for magnetic holding (16) is arranged on the base device (2) under a cover (39) made of plastic.

6. The fully automatic coffee machine (1) as claimed in claim 1, wherein the water outlet (8) is connectable by push fit to the connection opening (9).

7. The fully automatic coffee machine (1) as claimed in claim 1, wherein the magnetically acting coupling element (17) for magnetic holding (16) is arranged on the water tank (5) closer to a filling opening (19) than to the water outlet (8).

8. The fully automatic coffee machine (1) as claimed in claim 1, further comprising a magnetically acting counter-coupling element (20) configured for magnetic holding (16) is arranged on the base device (2).

9. The fully automatic coffee machine (1) as claimed in claim 8, wherein the connection opening (9) is arranged below the counter-coupling element (20).

10. The fully automatic coffee machine (1) as claimed in claim 1, wherein the connection opening (9) is formed on a support (24) for the water tank (5).

11. The fully automatic coffee machine (1) as claimed in claim 1, wherein the water tank (5) has a smaller horizontal dimension (26, 34), at least in a direction (25) in which it is magnetically held, than a vertical dimension (27).

12. The fully automatic coffee machine (1) as claimed in claim 1, wherein the water tank (5) in a usage position lies against a side face (30) of the base device which is free from guides.

13. The fully automatic coffee machine (1) as claimed in claim 1, wherein the lid (6) is connected to the water container (35) via a hinge.

14. The fully automatic coffee machine (1) as claimed in claim 1, wherein the magnetically acting coupling element (17) comprises at least one of a permanent magnet (18) or a material drawn into a magnetic field.

15. The fully automatic coffee machine (1) as claimed in claim 3, wherein one of the permanent magnets (18) is ball-shaped and another one of the permanent magnets (21) is bar-shaped.

16. The fully automatic coffee machine (1) as claimed in claim 4, wherein the at least one of the coupling element (17) or the counter-coupling element (20) that is arranged to be movable is rotatable about an axis which runs transversely and perpendicularly to a magnetic dipole moment.

17. The fully automatic coffee machine (1) as claimed in claim 6, wherein a magnetic holding force for the magnetic holding is oriented transversely to a push-fit direction (13) of the push-fit connection (12).

18. The fully automatic coffee machine (1) as claimed in claim 8, wherein the magnetically acting counter-coupling element (20) comprises at least one of a permanent magnet (21) or a material drawn into the magnetic field.

19. The fully automatic coffee machine (1) as claimed in claim 11, wherein the horizontal dimension (26, 34) amounts to a maximum of 50% of the vertical dimension (27).
